(19) United States
(12) Patent Application Publication
(10) Pub. No.: US 2019/0263362 A1
(43) Pub. Date: Aug. 29, 2019

(54) Method and Apparatus for Equalizing Pressure in a Plurality of Tires

(71) Applicant: John Hammer, Cedar City, UT (US)

(72) Inventor: John Hammer, Cedar City, UT (US)

(21) Appl. No.: 16/288,039

(22) Filed: Feb. 27, 2019

Related U.S. Application Data
(60) Provisional application No. 62/635,902, filed on Feb. 27, 2018.

(51) Int. Cl. B60S 5/04

(52) U.S. Cl. CPC B60S 5/04

(57) ABSTRACT

An apparatus for filling four or more tires simultaneously with air includes four or more fill hoses, each of the four or more fill hoses being between four and twenty feet in length and each of the four or more fill hoses adapted to connect to a tire fill valve of each of the four or more tires. A common manifold connects each of the four or more fill hoses allowing for passive tire filling through bidirectional communication of the air between the four or more tires. An air-input-port is attached to the common manifold allowing all of the tires to be inflated at the same time using active filling through an external air supply. The apparatus may comprise one or more valves attached to the common manifold. The apparatus may comprise one or more gauges attached to the common manifold.

### RELATED APPLICATIONS

This application claims priority to U.S. Provisional Patent No. 62/635,902 filed on Feb. 27, 2018, the disclosure of which is hereby incorporated by express reference thereto.

### SUMMARY

An apparatus for filling four or more tires simultaneously with air includes four or more fill hoses, each of the four or more fill hoses being between four and twenty feet in length and each of the four or more fill hoses adapted to connect to a tire fill valve of each of the four or more tires. A common manifold connects each of the four or more fill hoses allowing for passive tire filling through bidirectional communication of the air between the four or more tires. An air-input-port is attached to the common manifold allowing all of the tires to be inflated at the same time using active filling through an external air supply. The apparatus may comprise one or more valves attached to the common manifold. The apparatus may comprise one or more gauges attached to the common manifold.

A multi-tire inflator, deflator, and equalizer device has been developed. In one embodiment, an equalizer device attaches to all tires and it automatically equalizes the tire pressure so that all tires have the exact same PSI. ATV's and UTV's pull to one side because of unequal tire pressure causing a loss of power, speed and poor handling making the vehicle more dangerous to ride. The EZ Equalizer, equalizes tire pressure, stops the ATV from pulling due to unequal tire pressure, restores full power to the wheels, and greatly improves overall handling and performance of the vehicle. In another embodiment, tire pressures can be set to the proper level for every road condition in a simple and convenient way. Proper tire pressures make vehicles safer and more comfortable to ride while increasing vehicle handling. Proper tire pressures also increase the overall life of the tires and all drive terrain components of a vehicle. In another embodiment, an EZ Equalizer device includes: an injection molded plastic box with four hose fittings (two on each side), an air pressure gage, control knobs on the top of the box, four air hoses, air attachment fittings, an air release valve in the front end, and a inflating valve in the rear. In another embodiment, the EZ equalizer main body may be approximately 4″ wide by 8″ long and 3″ tall. Hoses extending from the main body portion may vary in length and quantity depending on the application. The length of hoses may range from eight foot long to twelve feet long, depending on the model of the EZ Equalizer and the intended use. In another embodiment, tires may be equalized by attaching an air hose fitting of the EZ Equalizer to all the tires of a vehicle. The tires then find equilibrium of pressure where all tires are at equal pressures. A set point pressure may be chosen for all tires or groups of tires such as front tires or rear tires. The EZ Equalizer allows for the tire pressures on all the tires to equalized to the exact same PSI and then to be adjusted to the same PSI on all of the tires at the same time. Prior art methods go to each tire (one at a time) with an air supply and a tire gage, bend over or kneel down on the hard and sometimes rough ground and fill or remove air from each of the tires and “try” to get all the tires at the same PSI, it is very time consuming and hard on the knees and back (especially for older people). And it is almost impossible to get the same PSI in all tires with a tire gage.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows an overall schematic of an EZ Equalizer in accordance with an embodiment of the invention;

FIG. 2 depicts an example of a main body portion of an EZ Equalizer in accordance with an embodiment of the invention; and

FIG. 3 shows a method in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, but is merely representative of certain examples of presently contemplated embodiments in accordance with the invention. The presently described embodiments will be best understood by reference to the drawings.

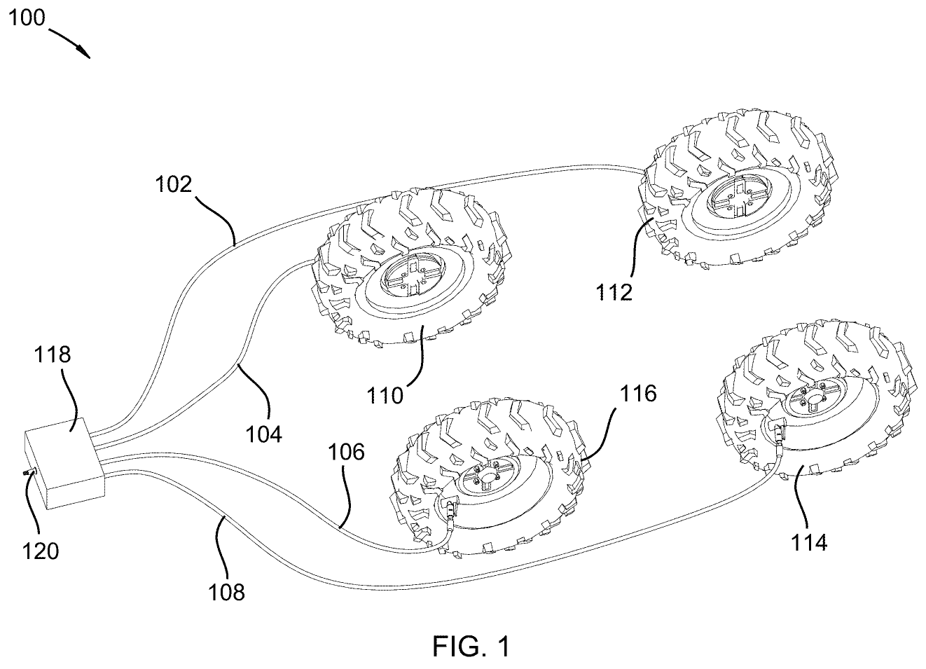

FIG. 1 shows an overall schematic diagram 100 of the EZ Equalizer. Vehicle tires 110-116 are connected to main body portion 118 by hoses 102-108. Main body portion 118 includes a supply port 120 and a plurality of input/output ports connected between hoses 102-108 and main body portion 118. Main body portion 118 may be made out of plastics, metals, fiber glass, carbon fiber materials, or combinations thereof. Main body portion 118 may include valves, fittings, one-way pneumatic valves, gages, check valves, manifolds, three-way valves, four-way valves, two-way valves, mechanical diverters, expansion tanks, and other pneumatic devices and fittings. Tires 110-116 may have unequal pressures within individual tires and therefore cause drag, pulling, and loss of power in a vehicle (not shown). The EZ Equalizer provides a simple and fast way to equalize pressures inside of tires 110-116. In some embodiments, it may be advantageous to have front vehicle tires 110 and 112 at the same pressure while rear tires 116 and 114 are at different equalized pressures from the front tires. A separate gage may be provided for each tire, and valves which are able to select groups of tires, individual tires, or all tires. Groups of tires, individual tires, or all tires may be selected for equalization, deflation, and/or inflation.

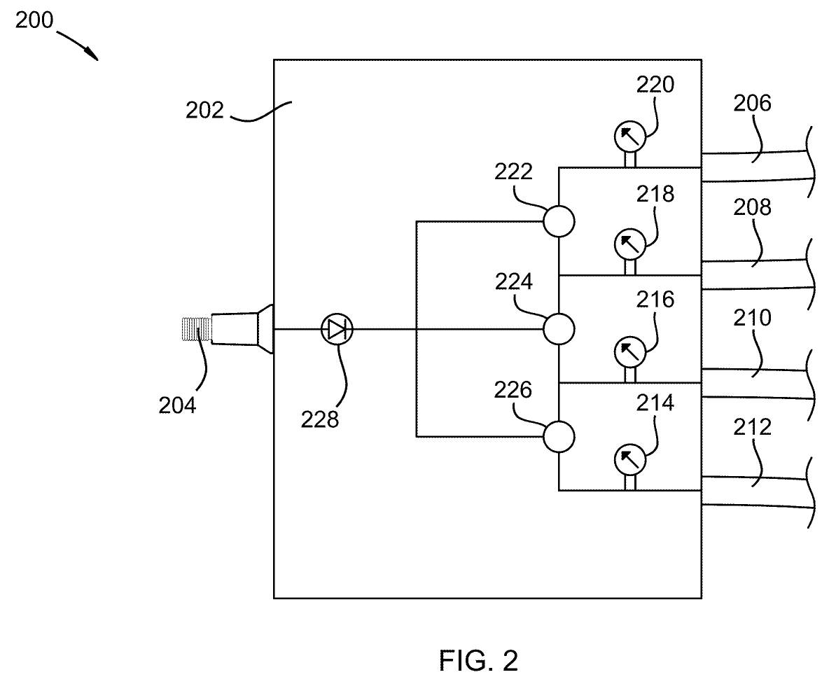

FIG. 2 shows example of a main body portion 202 of an EZ Equalizer 200 in accordance with an embodiment of the invention. Main body portion 202 houses various pneumatic fittings, instruments, valves, and lines which allow hoses 206-212 to equalize, fill, deflate, and connect to a plurality of tires of a vehicle. Hoses 206-212 represent a plurality of hoses from 2 to 22. Hoses 206-212 may be lengths from four feet to twenty feet. Different vehicles may require different lengths and different numbers of hoses. Gages 214-220 represent pressures within hoses 206-212 and inside of tires connected to hoses 206-212. A user of EZ Equalizer 200 may select tires for equalization, inflation, or deflation based on readings of gages 214-220. Valves 222-226 may be used to equalize, inflate, or deflate tires based on a user selected position of valves 222-226. A check valve 228 may be used to keep air from one or more tires from exiting port 204. Port 204 may be connected to an air compressor or air pump to provide inflation pressure for tires connected to EZ Equalizer 202. Other devices and configurations may be possible and used to control and route airflow in and through main body portion 202.

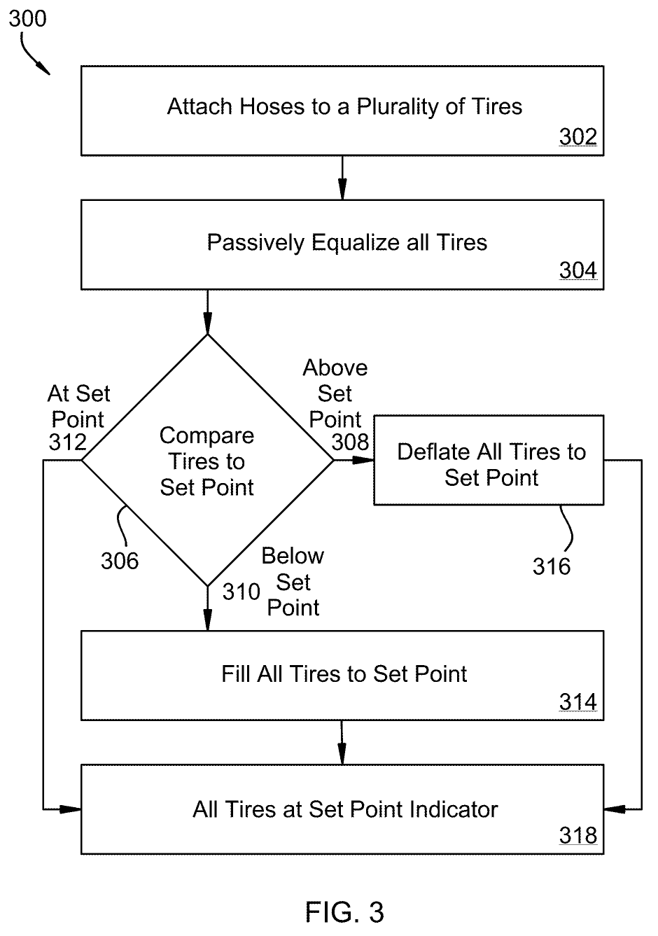

FIG. 3 shows a method 300 in accordance with an embodiment of the invention.

At step 302 two or more hoses are attached to two or more tires. Then automatically the connected tires equalize in pressure 304. A user is then able to look at one or more gauges and determine 306 if the connected tires are at a desired pressure 312, over pressure 308 or under pressure 314. A user may then make necessary adjustments to valves, knobs, or buttons which allow the tires to achieve optimal pressure. When the connected tires achieve optimal pressure, a gage, indicator, or other visual aid may signal to the user that the tires are at optimal pressure.

The systems and methods disclosed herein may be embodied in other specific forms without departing from their spirit or essential characteristics. The described embodiments are to be considered in all respects only as illustrative and not restrictive. All changes which come within the meaning and range of equivalency of the claims are to be embraced within their scope.

1. An apparatus for filling four or more tires simultaneously with air comprising:
four or more fill hoses, each of the four or more fill hoses being between four and twenty feet in length, and each of the four or more fill hoses adapted to connect to a tire fill valve of each of the four or more tires;
a common manifold connecting each of the four or more fill hoses allowing bidirectional communication of the air between the four or more tires; and
an air-input-port attached to the common manifold.

2. The apparatus of claim 1, further comprising one or more valves attached to the common manifold.

3. The apparatus of claim 2, further comprising one or more gauges attached to the common manifold.
